(19) United States
(12) Patent Application Publication
(10) Pub. No.: US 2002/0135907 A1
(43) Pub. Date: Sep. 26, 2002

(54) Vehicle rear view mirror assembly including adaptor and turn signal

(76) Inventor: Joseph A. Valentino, Media, PA (US)

Correspondence Address: FINNEGAN, HENDERSON, FARABOW, GARRETT &, DUNNER LLP, 1300 I STREET, NW, WASHINGTON, DC, 20005, US

(21) Appl. No.: 09/814,120

(22) Filed: Mar. 22, 2001

(51) Int. Cl. G02B 5/08; G02B 7/18; G02B 7/182

(52) U.S. Cl. 359/844; 359/838; 359/871

(57) ABSTRACT

A vehicle rear view mirror assembly. A mirror frame attaches to an exterior side of a vehicle, the mirror frame has a first set of dimensions, and a mirror has a second set of dimensions. An adaptor has two sides. One side, having the first set of dimensions, fits into the mirror frame, and the other side, having the second set of dimensions, receives and holds the mirror. By use of the appropriate adaptor, a standard-sized mirror can be mounted in a wide variety of different dimensional mirror frames. A turn signal can also be mounted in a turn signal mounting portion in the adaptor.

### BACKGROUND OF THE INVENTION

1. Field of the Invention

The present invention relates to a rear view mirror for a vehicle, and more particularly to rear view mirror mounted on an exterior side of a large vehicle such as a truck with a semi-detached tractor trailer.

2. Description of the Related Art

Large vehicles, such as trucks with semi-detached tractor trailers, typically have a cab with large rear view mirrors mounted on an exterior of the cab. Even more typically, such mirrors are mounted in frames attached to the right and left-side doors of the cab. The frames come in a number of sizes and shapes, selected by different truck manufacturers, and some frame sizes and shapes are even proprietary to certain truck manufacturers.

The rear view mirrors mounted in these mirror frames typically are standard convex or concave mirrors. New rear view mirrors have recently come on the market, however, including remote-controlled mirrors, which pivot within the frame when the truck either turns or commences a lane-change, in order to provide the truck driver with an improved rear-view field of vision, and many truck owners wish to backfit their trucks with these mirrors, while at the same time many truck manufacturers want to install these mirrors in their frames as part of new truck construction.

This has created a problem, however, because it is difficult and expensive to manufacture these mirrors in the wide variety of shapes and dimensions needed to fit the wide variety of differently-shaped and dimensioned side rear-view mirror frames discussed above. It would be much simpler and cheaper to have a means by which the mirrors themselves could be made to a standard size, and still be capable of being mounted in all of the different-shaped and different-sized side rear-view mirror frames on the market.

Another problem with traditional tractor-trailered vehicles is a difficulty experienced by automobile motorists driving behind the truck seeing the electric turn signals flashing on the backs of the truck trailers. These flashing turn signals traditionally are mounted low on the rear of the trailer. In this position, the turn signal can be below the line of sight of many motorists in automobiles traveling behind the truck. In addition, because such turn signals are close to the road, they often are obscured by dirt and road grime, further decreasing their visibility.

It therefore is desirable to identify a location higher on the truck to mount the turn signal where it would be more visible to automobile motorists traveling behind the truck.

It has been proposed to mount a turn signal on or proximate the side rear view mirror of the truck, but once again, the many different sizes and shapes of the variety of truck side rear-view mirror frames has made this proposal appear expensive and impractical.

### SUMMARY OF THE INVENTION

The present invention has been conceived in order to obviate one or more of the shortcomings described above with the related art.

To achieve the aforementioned goal of the invention, a vehicle rear view mirror adaptor has been provided with a first side having a first preselected set of dimensions corresponding to a preselected set of dimensions of a vehicle mirror frame, and a second side having a second preselected set of dimensions and structure for receiving and holding a mirror having the second preselected set of dimensions. The first side of the adaptor is insertable into the mirror frame and the second side of the adaptor holds the mirror.

In one embodiment, the adaptor also includes a turn signal mounting portion for mounting a turn signal.

Preferably, the first preselected set of dimensions of the mirror frame includes a first height and width, and the second preselected set of dimensions of the mirror includes a second height and width, with at least one of the heights and the widths being different from the other.

In this manner, using an appropriate adaptor, a mirror with a standard height and width can be fitted, via the appropriate adaptor having an appropriate first set of dimensions, into a plurality of mirror frames, having a variety of shapes or dimensions.

The invention also includes a method of assembling a rear view mirror on a vehicle. The method includes selecting a mirror frame, attachable to an exterior side of the vehicle, having a first preselected set of dimensions, selecting a mirror having a second preselected set of dimensions, preparing an adaptor having two sides, including a first side with the first preselected set of dimensions, and a second side having the second preselected set of dimensions. The second side also includes structure to receive and hold the mirror in place. The method also includes inserting the first side of the adaptor into the mirror frame and fixing the adaptor in place, and inserting the mirror into the second side of the adaptor.

In one embodiment, the adaptor can also include a turn signal mounting portion and a turn signal is mounted in this mounting portion.

Preferably, the first preselected set of dimensions differs from the second preselected set of dimensions in at least one of height and width, so that a standard-sized mirror can be mounted, via an adaptor having the appropriate first set of dimensions, into a variety of different-sized and different-shaped mirror frames.

Additional advantages of the invention will be set forth in the description which follows, and in fact will be apparent from the description, or may be learned by practice of the invention. The objections and advantages of the invention may be realized and obtained by means of the combinations set forth in the appended claims.

### BRIEF DESCRIPTION OF THE DRAWINGS

The accompanying drawings, which are incorporated in and constitute a part of the specification, illustrate preferred embodiments of the invention. Together with the general description given above and the detailed description of the preferred embodiments given below, the drawings serve to explain the principles of the invention.

FIG. 1 is a perspective view of a cab of a truck with a side rear-view mirror frame having a preselected shape and preselected dimensions;

FIG. 2 is a rear view of a side rear view mirror frame having a preselected shape and preselected dimensions that are different from those of the mirror frame attached to the truck cab in FIG. 1;

FIG. 3 is a perspective view of an adaptor in accordance with the invention;

FIG. 4 is a perspective view of a mirror frame, mirror, and adaptor in accordance with the invention;

FIG. 5 is a perspective view similar to FIG. 4, except the adaptor includes a turn signal mounting portion with a turn signal mounted therein;

FIG. 6 is a perspective exploded part view of a mirror frame, adaptor, and mirror in accordance with the invention;

FIG. 7 is a perspective view of a mirror frame with the adaptor attached; and

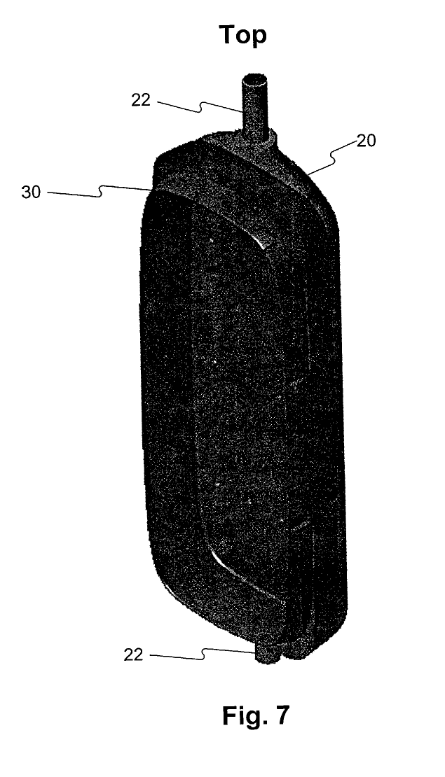

FIG. 8 is a perspective view of the components of FIG. 6 assembled into a rear view mirror assembly.

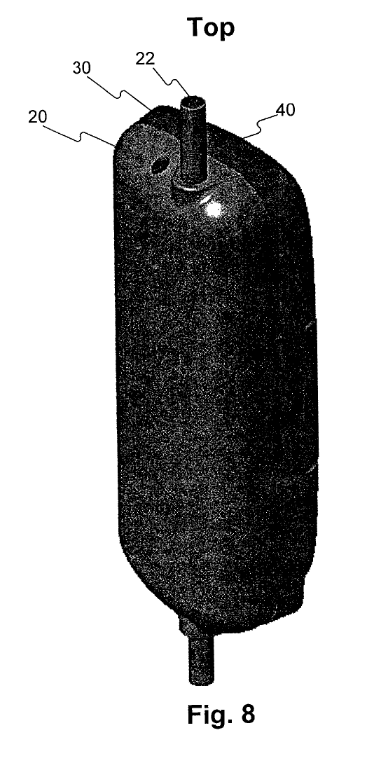

### DESCRIPTION OF THE PREFERRED EMBODIMENTS

Reference will now be made to the present preferred embodiments of the invention as broadly illustrated in the accompanying drawings.

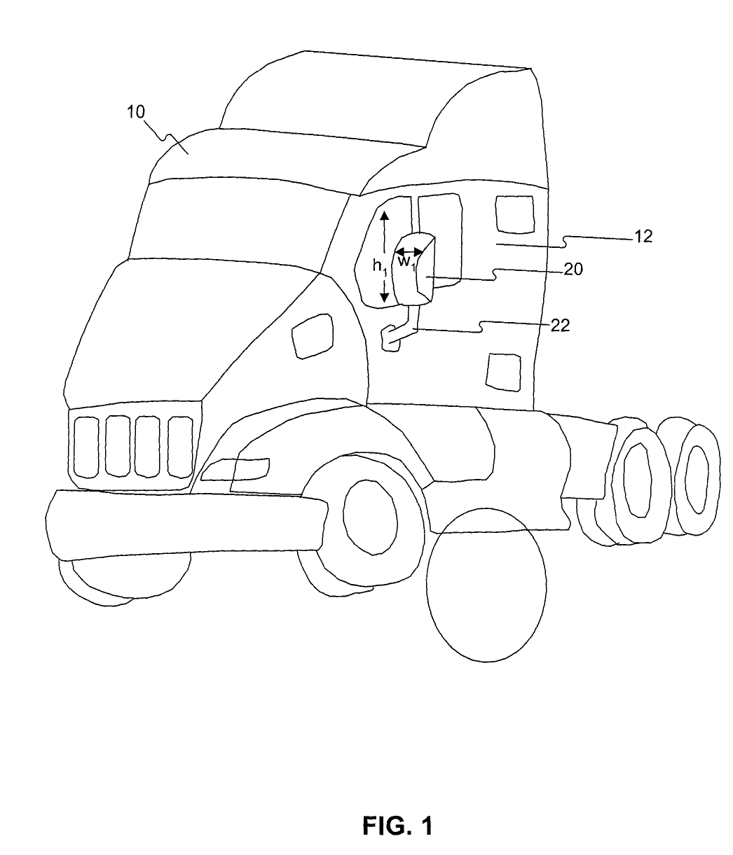

Referring to FIG. 1, a truck cab 10, configured to haul a semi-detached trailer (not shown), includes a side rear view mirror frame 20 attached via a linkage 22 to a door 12 of the cab 10. Mirror frame 20 has a shape that is, in this case, generally rectangular, and has a first preselected set of dimensions, including a first height h1 and a first width w1. The particular mirror frame 20 shown in FIG. 1 is common on truck cabs built by the PETERBILT® company, and most of these mirror frames 20 have substantially the same shape, height, and width.

The invention is not restricted to any particular shape, height, and width of mirror frame 22, however, but instead is applicable to a wide variety of mirror frame shapes, heights and widths.

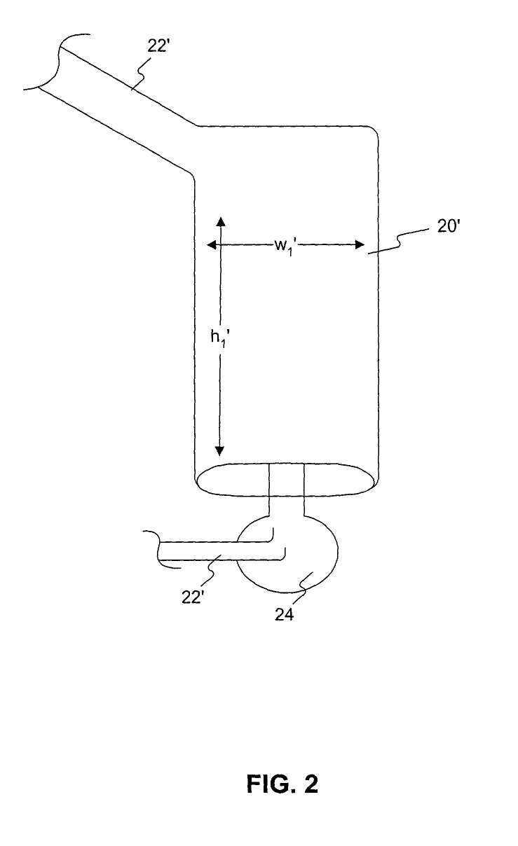

For example, referring to FIG. 2, a second example of a side rear view mirror frame 20′ is shown, including linkage 22′ for attachment to a side of a truck cab 10 (not shown in FIG. 2). This particular mirror frame 20′ is what is known as a “west coast mirror” because in addition to an upper rectangular mirror frame, it also includes a lower circular frame portion 24′ where a circular convex mirror can be mounted. The upper rectangular mirror frame 20′ has a height of h1′ and a width w1′, that may differ somewhat from the height and width h1, w1 of the mirror frame 20 in FIG. 1.

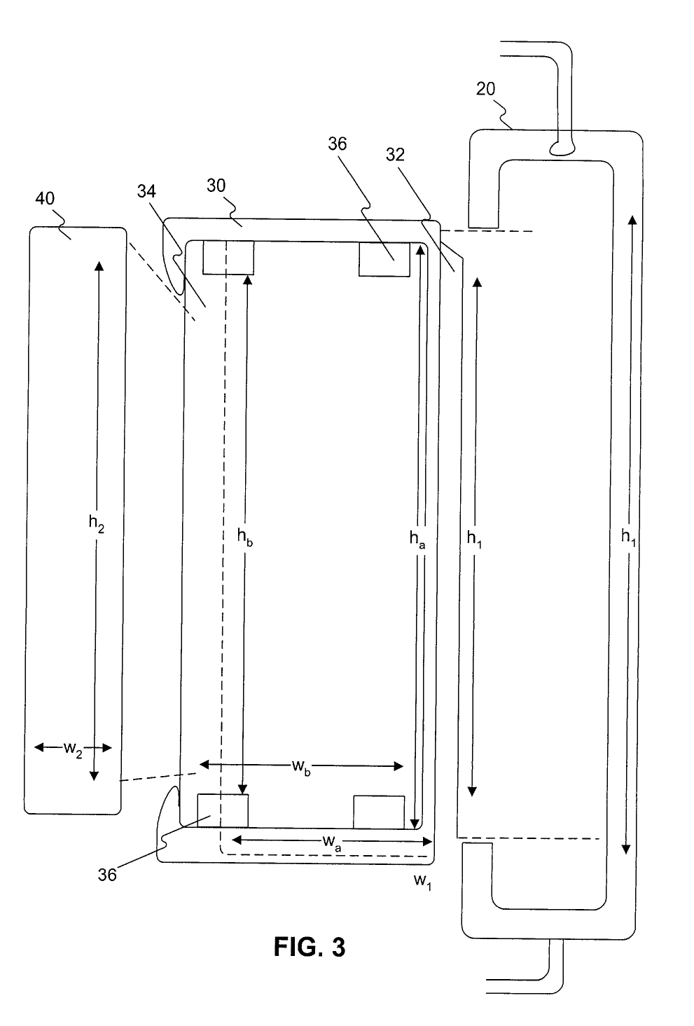

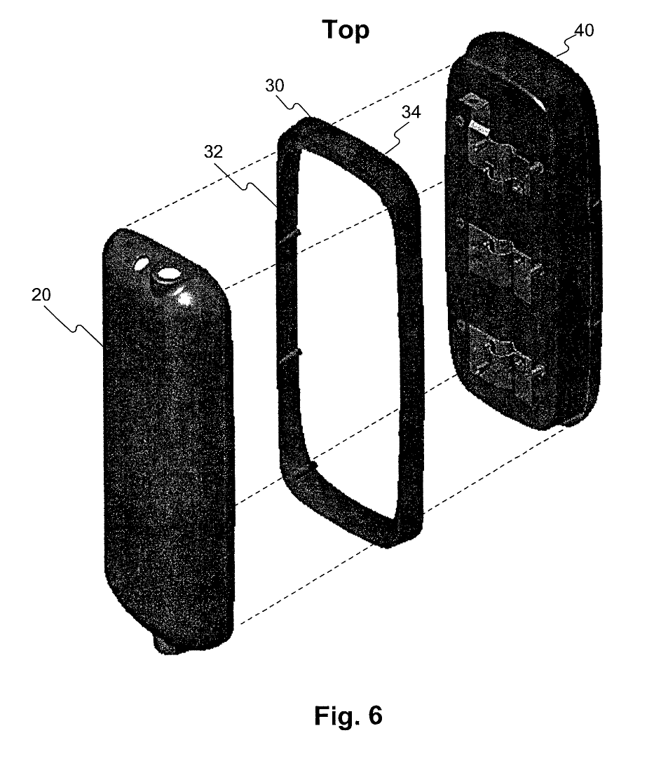

In accordance with the invention, and referring to FIGS. 3 and 6, a vehicle rear view mirror adaptor 30 is provided, including a first side 32 and a second side 34. The first side 32 has a height ha corresponding to height h1 of a mirror frame 20, and a width wₐ corresponding to w1 of the same mirror frame 20. It will be understood that the heights ha and widths wₐ of the first side 32 of each adaptor 30 will correspond to the heights and widths of several different mirror frames 20, as necessary to cover the wide gamut of mirror frames 20 on the market, and that first side 32 of the particular adaptor 30 shown here will be insertable into the respective mirror frame 20 having the preselected dimensions h1 and w1. Second side 34 of adaptor 30 has a second height h_{b} and a second width w_{b}, and these dimensions correspond to a height h2 and a width w2 of a mirror 40. Any suitable rear view mirror 40 is suitable, as long as it has the second set of dimensions h2 and w2 corresponds to h_{b} and w_{b}. A particularly desirable mirror is an automatic remote control mirror, manufactured and sold by ARCM Corp. of West Chester, Pa. First side 34 of the adaptor 30 also includes means to receive and hold mirror 40 in place, for example mirror clips 36, or other well-known mirror holding means.

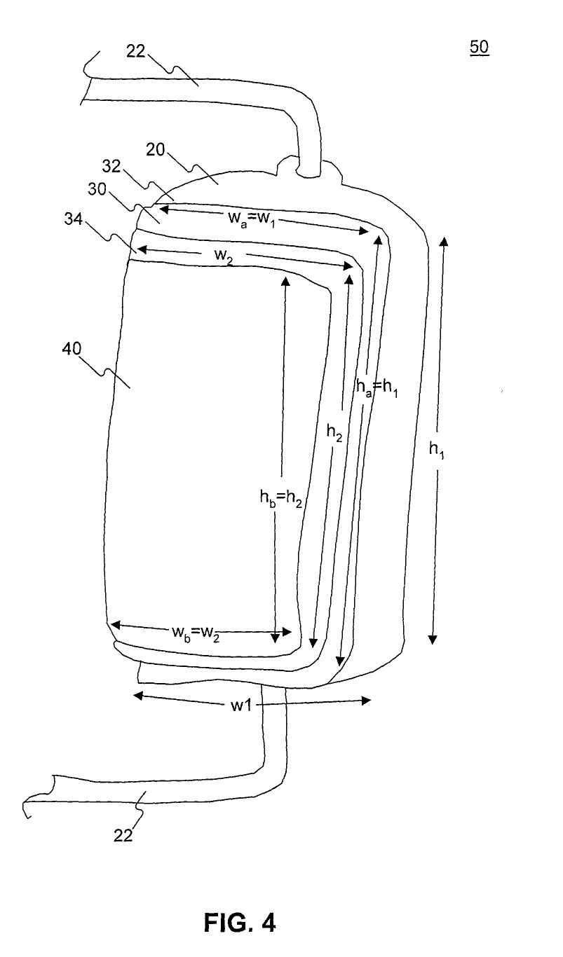

Referring now to FIG. 4, a mirror 40, adaptor 30, and mirror frame 20 are assembled into a side rear view mirror assembly 50 which is attachable via linkage 22 to a side exterior of a truck cab 10 (not shown). In mirror assembly 50 in FIG. 4, frame 20 has height h₁ and width w₁, mirror 40 has height h₂ and width w₂. Adaptor 30 has one side 32, facing the frame with height hₐ and width wₐ corresponding to h₁ and w₁ and another side 34, facing the mirror with height h_{b} and width w_{b} corresponding to h₂ and w₂ of the mirror. At least one of h₁, h₂, w₁ or w₂ are different from the other, so that mirror 40 would not have been able to fit into mirror frame 20 absent the presence of adaptor 30. Because the first side 32 of adaptor 30 has the same dimensions as mirror frame 20, and the second side of adaptor 30 has the same dimensions as mirror 40, adaptor 30 fits into mirror frame 20 and can receive and hold in place mirror 40.

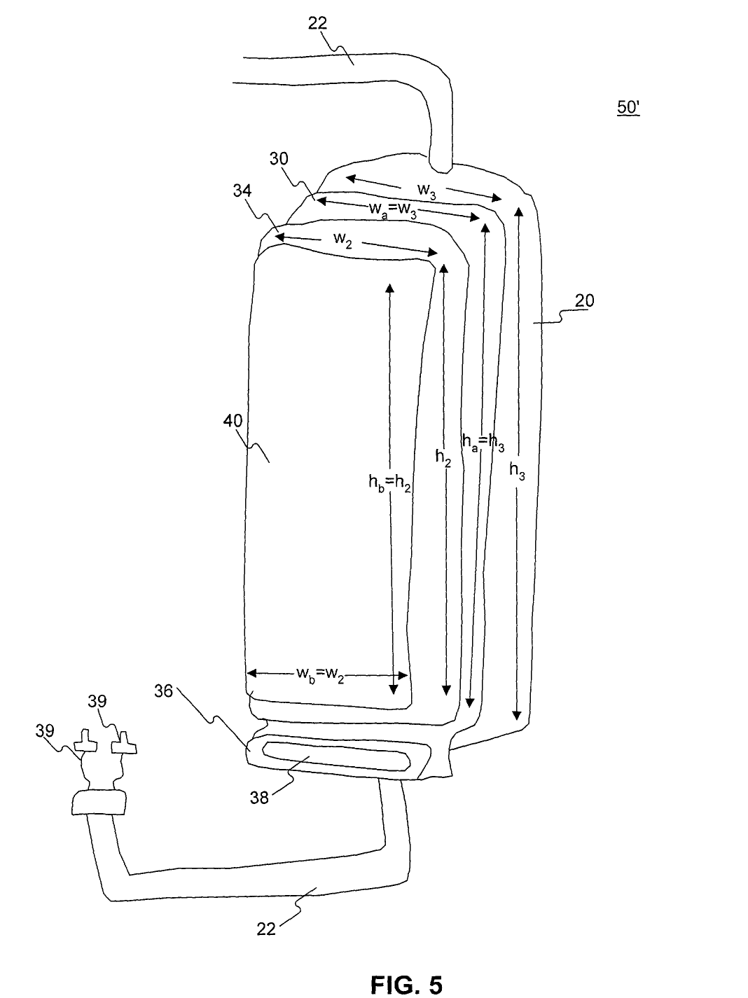

Referring now to FIG. 5, another mirror frame 20 is shown, in this case having a height h3 and a width w3. The same mirror 40, having height h_{b}=h₂ and width w_{b}=w₂ is mounted in this frame 20, via an adaptor 30. The adaptor 30 has first side 32 with height h3 and width w3, corresponding to the dimensions of this particular mirror frame 20; and a second side 34 with height h2 and width w2 corresponding to a height and width of mirror 40, so that, with this adaptor 30, the same mirror 40 that was used in the embodiment of FIG. 4, can be used with a different-sized mirror frame 20.

FIG. 5 further depicts a different embodiment from FIG. 4, because in FIG. 5 adaptor 30 includes a turn signal mounting portion 36. The signal mounting portion 36, a generally rectangular frame portion, can be provided at any suitable location on adaptor 30, but preferably is positioned proximate the bottom of adaptor 30, below the mirror 40, so that the flashing turn signal will not interfere with the driver's view of mirror 40 and vice versa. A standard electric flashing turn signal 38 is mounted in mounting portion 36, and electrical leads 39 run through lower linkage 22 to provide an electrical signal to turn signal 38. Although the turn signal 38 is not required to be mounted in this position, mounting the turn signal here will place it much farther above the typical mounting position at the bottom rear of the trailer, so this turn signal should prove to be more visible to motorists in automobiles behind the truck 10

It will be understood that, although all of the shapes of mirror frames 20 shown and described above are generally rectangular, that differently-shaped mirror frames 20 can be used, as long as the respective adaptor 30 is configured with its first side 32 having substantially the same shape (as well as substantially the same dimensions) as the respective mirror frame 20, so that first side 32 of the respective adaptor fits within the mirror frame 20. As long as the second side 34 of adaptor 30 has the same dimensions as the mirror 40 to be mounted thereto, any sized or shaped mirror 40 can be mounted to any sized or shaped mirror frame 20, via the appropriate adaptor 30.

Additional advantages and modifications will readily occur to those of ordinary skill in the art. The invention in its broader aspects, therefore, is not limited to the specific details, and representative structures shown and described above. Departures may be made from such details and structures without departing from the spirit and scope of the invention. The scope of the invention is determined by the claims and their legal equivalents.

What is claimed is:

1. A method of assembling a rear view mirror on a vehicle, comprising:
selecting a mirror frame having a first preselected set of dimensions, attachable to an exterior side of the vehicle,
selecting a mirror having a second preselected set of dimensions;
preparing an adaptor having first and second sides, the first side having the first preselected set of dimensions, and the second side having the second preselected set of dimensions and holding means to receive and hold said mirror;
inserting said first side of said adaptor into said mirror frame; and
inserting said mirror into said holding means in said second side of said adaptor.

2. The method of claim 1, wherein said adaptor further includes a turn signal mounting portion, and further comprising a step of mounting a turn signal in said turn signal mounting portion.

3. A vehicle rear view mirror adaptor, comprising:
a first side having a first preselected set of dimensions corresponding to a preselected set of dimensions of a vehicle mirror frame; and
a second side having a second preselected set of dimensions and holding means for receiving and holding a mirror having the second preselected set of dimensions;
wherein said first side is insertable into the vehicle mirror frame.

4. The adaptor of claim 3, further comprising a turn signal mounting portion for mounting a turn signal.

5. The adaptor of claim 3, wherein the first preselected set of dimensions includes a first height and a first width.

6. The adaptor of claim 5, wherein the second preselected set of dimensions includes a second height and a second width, at least one of said second height and second width differing from said first height and said first width.

7. A vehicle turn signal assembly, comprising:
a rear view mirror frame mounted on a side exterior of the vehicle;
a mirror mounted in a first portion of said mirror frame; and
a turn signal mounted in a second portion of said mirror frame.

8. The assembly of claim 7, further comprising an adaptor provided between said mirror and said mirror frame, said adaptor having a first side having first dimensions corresponding to dimensions of said mirror frame, a second side having second dimensions corresponding to dimensions of said mirror, and holding means for receiving and holding said mirror, said first side being insertable into said mirror frame, and a turn signal mounting portion supporting a turn signal.

9. The assembly of claim 7, wherein said mirror frame has an upper portion and a lower portion, and said turn signal mounting portion of said adaptor is located proximate said lower portion when said adaptor is inserted in said mirror frame.

10. The assembly of claim 8, wherein said first dimensions include a first height and a first width and said second dimensions include a second height and a second width, at least one of said first height and first width being different from said second height and said second width.

11. The assembly of claim 7, wherein said mirror frame is mounted on a side exterior of a cab for hauling a semi-detached tractor trailer.

12. A vehicle rear view mirror assembly, comprising:
a rear view mirror frame mounted on the vehicle;
a mirror mounted in a first portion of said mirror frame; and
a turn signal mounted in a second portion of said mirror frame.

13. The assembly of claim 12, further comprising an adaptor provided between said mirror and said mirror frame, said adaptor having a first side having first dimensions corresponding to dimensions of said mirror frame, a second side having second dimensions corresponding to dimensions of said mirror, and holding means for receiving and holding said mirror, said first side being insertable into said mirror frame, and a turn signal mounting portion wherein said turn signal is mounted.

14. The assembly of claim 12, wherein said mirror frame has an upper portion and a lower portion, and said turn signal mounting portion of said adaptor is located proximate said lower portion when said adaptor is inserted in said mirror frame.

15. The assembly of claim 12, wherein said first dimensions include a first height and a first width and said second dimensions include a second height and a second width, at least one of said first height and first width being different from said second height and said second width.

16. The assembly of claim 12, wherein said mirror frame is mounted on a side exterior of a cab for hauling a semi-detached tractor trailer.
